(19) United States
(12) Patent Application Publication
(10) Pub. No.: US 2018/0070284 A1
(43) Pub. Date: Mar. 8, 2018

(54) APPARATUSES AND METHODS FOR PROPAGATING PACKETS IN A WIRELESS MESH NETWORK SUPPORTING BOTH FLOODING-BASED AND ROUTING-BASED RELAYING

(71) Applicant: MEDIATEK INC., Hsin-Chu (TW)

(72) Inventor: Li-Chun KO, Taipei City (TW)

(21) Appl. No.: 15/643,991

(22) Filed: Jul. 7, 2017

Related U.S. Application Data
(60) Provisional application No. 62/383,498, filed on Sep. 5, 2016.

(51) Int. Cl. H04W 40/02; H04L 12/721

(52) U.S. Cl. CPC H04W 40/02; H04W 84/18; H04L 45/32

(57) ABSTRACT

A wireless communication device, serving as an edge node in a wireless mesh network, is provided. The wireless communication device includes a wireless transceiver and a controller. The wireless transceiver performs wireless transmission and reception in the wireless mesh network. The controller uses a routing-based propagation mechanism to transmit, via the wireless transceiver, a data packet to a destination node in the wireless mesh network when a route is known towards the destination node, and uses a flooding-based propagation mechanism to transmit, via the wireless transceiver, the data packet to the destination node when receiving a routing control message invalidating the route.

### CROSS REFERENCE TO RELATED APPLICATIONS

This Application claims priority of U.S. Provisional Application No. 62/383,498, filed on Sep. 5, 2016, the entirety of which is incorporated by reference herein.

### BACKGROUND OF THE APPLICATION

### Field of the Application

The application relates generally to wireless communications, and more particularly, to apparatuses and methods for propagating packets in a wireless mesh network supporting both flooding-based and routing-based relaying.

### Description of the Related Art

The use of wireless mesh networks has increased in recent years to improve the range of wireless communications. A wireless mesh network typically includes a plurality of wireless nodes that communicate with one another to propagate packets. For example, in a multi-hop wireless mesh network, a packet is propagated from a source node, or an originating node, to a destination node by “hopping” from one wireless node to another until the packet reaches the destination node. As such, each node in the wireless mesh network operates as both a receiver and a transmitter to communicate packets between intermediate nodes.

Flooding is a network operation in which a packet is sent by one node to every other node in a wireless mesh network. Each wireless node that receives that packet, and hasn't received it before, forwards it to every other known neighboring node except for the originating node. The flooding of packets can be performed in either unicast or broadcast transmissions. Unicast transmissions are point-to-point, one node to another, with an acknowledgment packet sent back as a reply. Unicast transmissions are a reliable means of communication, but they can be problematic in very dense networks because the number of unicast packets needed to perform the flooding operation increases quadratically with the number of nodes in a wireless mesh network. Broadcast transmissions are point-to-multipoint, one node to every other node within the range of wireless communications. In a broadcast transmission, the number of data packets necessary to flood increases linearly with the number of nodes. In this regard, flooding with broadcast transmissions is more efficient than flooding with unicast transmissions. However, broadcast transmissions do not acknowledge receipt of data packets, so they are considered less reliable than unicast transmissions.

With routing, a packet is propagated along a path or route by hopping from node to node until it reaches the destination node. During the routing operation, each node needs to communicate the routing information to other nodes in the wireless mesh network. Each node then determines what to do with the packet it receives—to either pass it on to the next node or keep it, depending on the protocol. The routing operation should always attempt to ensure that the packet is propagated with the most appropriate (fastest) route to the destination node.

In most cases, routing is preferred over flooding in a wireless mesh network supporting both flooding-based and routing-based relaying, since routing incurs less traffic. However, when a route fails during a packet propagation using routing-based relaying, the source node will need to find another valid route for packet retransmission. Note that the route discovery process takes time, which results in long latency, and in the worst case in which no alternative route is found, packet reachability is degraded.

### BRIEF SUMMARY OF THE APPLICATION

In a first aspect of the application, a wireless communication device, serving as an edge node in a wireless mesh network, is provided. The wireless communication device comprises a wireless transceiver and a controller. The wireless transceiver is configured to perform wireless transmission and reception in the wireless mesh network. The controller is configured to use a routing-based propagation mechanism to transmit, via the wireless transceiver, a data packet to a destination node in the wireless mesh network when a route is known towards the destination node, and use a flooding-based propagation mechanism to transmit, via the wireless transceiver, the data packet to the destination node when receiving a routing control message invalidating the route.

In a second aspect of the application, a method for a wireless communication device serving as an edge node to propagate packets in a wireless mesh network is provided. The method comprises the steps of: using a routing-based propagation mechanism to transmit a data packet to a destination node in the wireless mesh network when a route is known towards the destination node; and using a flooding-based propagation mechanism to transmit the data packet to the destination node when receiving a routing control message invalidating the route.

In a third aspect of the application, a wireless communication device, serving as a friend relay of an edge node in a wireless mesh network, is provided. The wireless communication device comprises a wireless transceiver and a controller. The wireless transceiver is configured to perform wireless transmission and reception in the wireless mesh network. The controller is configured to buffer a routing control message and a data packet for the edge node when the edge node enters a sleep mode, and prioritize forwarding the routing control message over forwarding the data packet to the edge node when the edge node wakes up from the sleep mode.

In a fourth aspect of the application, a method for a wireless communication device serving as a friend relay of an edge node to propagate packets in a wireless mesh network is provided. The method comprises the steps of: buffering a routing control message and a data packet for the edge node when the edge node enters a sleep mode; and prioritizing forwarding the routing control message over forwarding the data packet to the edge node when the edge node wakes up from the sleep mode.

Other aspects and features of the application will become apparent to those with ordinary skill in the art upon review of the following descriptions of specific embodiments of the wireless communication devices and methods for propagating packets in a wireless mesh network.

### BRIEF DESCRIPTION OF THE DRAWINGS

The application can be more fully understood by reading the subsequent detailed description and examples with references made to the accompanying drawings, wherein:

FIG. 1 is a block diagram illustrating a wireless communication device according to an embodiment of the application;

FIG. 2 is a flow chart illustrating the method for a wireless communication device serving as an edge node to propagate packets in a wireless mesh network according to an embodiment of the application;

FIG. 3 is a flow chart illustrating the method for a wireless communication device serving as a friend relay of an edge node to propagate packets in a wireless mesh network according to an embodiment of the application; and

FIGS. 4A to 4D are schematic diagrams illustrating packet propagation according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The Bluetooth specifications are used to teach the spirit of the application, and the application is not limited thereto.

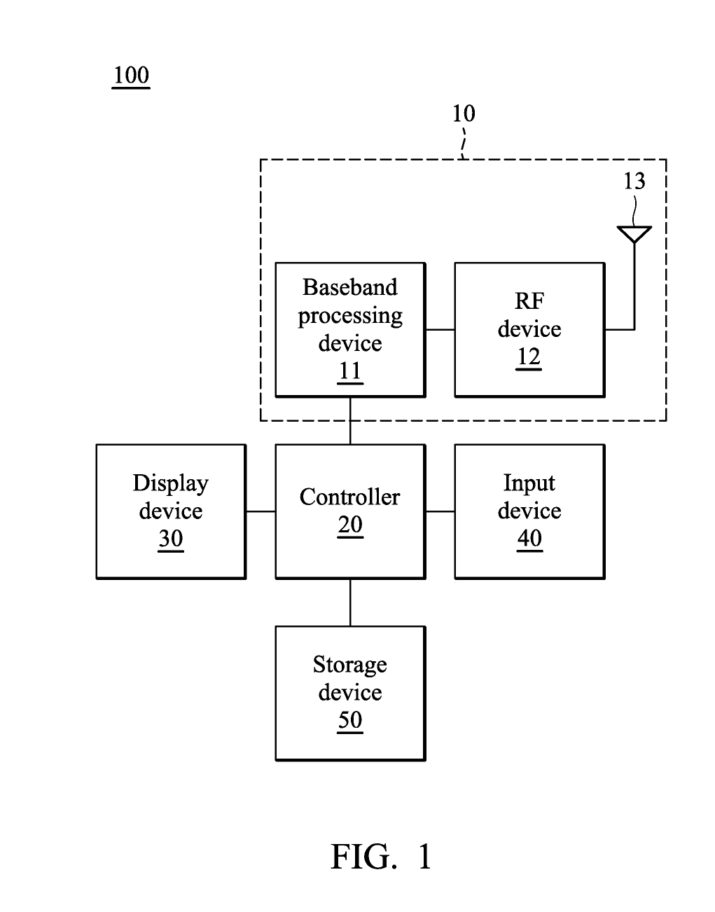

FIG. 1 is a block diagram illustrating a wireless communication device according to an embodiment of the application. The wireless communication device 100 is a Bluetooth Mesh Routing-enabled node supporting both the flooding-based propagation mechanism and the routing-based propagation mechanism, or may be a node supporting only the flooding-based propagation mechanism. In one embodiment, when using the flooding-based propagation mechanism, packets are propagated in the flood-relaying based data channel; and when using the routing-based propagation mechanism, packets are propagated in the routing-based data channel.

As shown in FIG. 1, the wireless communication device 100 includes a wireless transceiver 10, a controller 20, a display device 30, an input device 40, and a storage device 50. For example, wireless communication device 100 may be a mobile phone, panel Personal Computer (PC), notebook, smart TV, gaming console, or any computing device which supports wireless communications, such as Bluetooth communications.

The wireless transceiver 10 includes a baseband processing device 11, a Radio Frequency (RF) device 12, and an antenna 13. The baseband processing device 11 may contain multiple hardware components to perform baseband signal processing, including Analog-to-Digital Conversion (ADC)/Digital-to-Analog Conversion (DAC), gain adjusting, modulation/demodulation, encoding/decoding, and so on. The RF device 12 may receive RF wireless signals via the antenna 13, convert the received RF wireless signals to baseband signals, which are processed by the baseband processing device 11, or receive baseband signals from the baseband processing device 11 and convert the received baseband signals to RF wireless signals, which are later transmitted via the antenna 13. The RF device 12 may also contain multiple hardware components to perform radio frequency conversion. For example, the RF device 12 may comprise a mixer to multiply the baseband signals with a carrier oscillated in the radio frequency of the supported wireless technologies, wherein the radio frequency may be 2.4 to 2.485 GHz utilized in the Bluetooth technology, or 2.4 GHz, 3.6 GHz, 4.9 GHz, or 5 GHz utilized in the Wi-Fi technology, or another radio frequency, depending on the wireless technology in use.

The controller 20 may be a general-purpose processor, Micro-Control Unit (MCU), Digital Signal Processor (DSP), Application Processor (AP), or the like, which includes various circuits for providing the function of data processing and computing, controlling the wireless transceiver 10 for wireless communications, sending a series of frame data (e.g. representing text messages, graphics, images, etc.) to the display device 30, receiving signals from the input device 40, or storing and retrieving data to and from the storage device 50. In particular, the controller 20 coordinates the aforementioned operations of the wireless transceiver 10, the display device 30, the input device 40, and the storage device 50 for performing the method of the present application. In another embodiment, the controller 20 can be software or firmware or program commands that can be executed by a general-purpose processor, MCU, DSP, AP, or the like, to perform the aforementioned operations of the wireless transceiver 10, the display device 30, the input device 40, and the storage device 50 for performing the method of the present application.

As will be appreciated by persons skilled in the art, the circuits will typically comprise transistors that are configured in such a way as to control the operation of the circuitry in accordance with the functions and operations described herein.

In another embodiment, the controller 20 may be incorporated into the wireless transceiver 10, serving as a baseband processor.

The display device 30 may be a Liquid-Crystal Display (LCD), Light-Emitting Diode (LED) display, or Electronic Paper Display (EPD), etc., for providing a display function. Alternatively, the display device 30 may further include one or more touch sensors disposed thereon or thereunder for sensing touches, contacts, or approximations of objects, such as fingers or styluses.

The input device 40 may include one or more buttons, a keyboard, a mouse, a touch pad, a video camera, a microphone, and/or a speaker, etc., serving as the Man-Machine Interface (MIMI) for interaction with users.

The storage device 50 is a non-transitory machine-readable storage medium, including a memory, such as a FLASH memory or a Non-volatile Random Access Memory (NVRAM), or a magnetic storage device, such as a hard disk or a magnetic tape, or an optical disc, or any combination thereof for storing instructions or program code of communication protocol or applications.

It should be understood that the components described in the embodiment of FIG. 1 are for illustrative purposes only and are not intended to limit the scope of the application. For example, the wireless communication device 100 may include more components to support cellular technologies, such as the Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA2000) technology, Time Division-Synchronous Code Division Multiple Access (TD-SCDMA) technology, Worldwide Interoperability for Microwave Access (WiMAX) technology, Long Term Evolution (LTE) technology, Time-Division LTE (TD-LTE) technology, and LTE-Advanced (LTE-A) technology, etc. Alternatively, the wireless transceiver 10 may support one or more of the aforementioned cellular technologies, in addition to the Bluetooth technology or Wi-Fi technology.

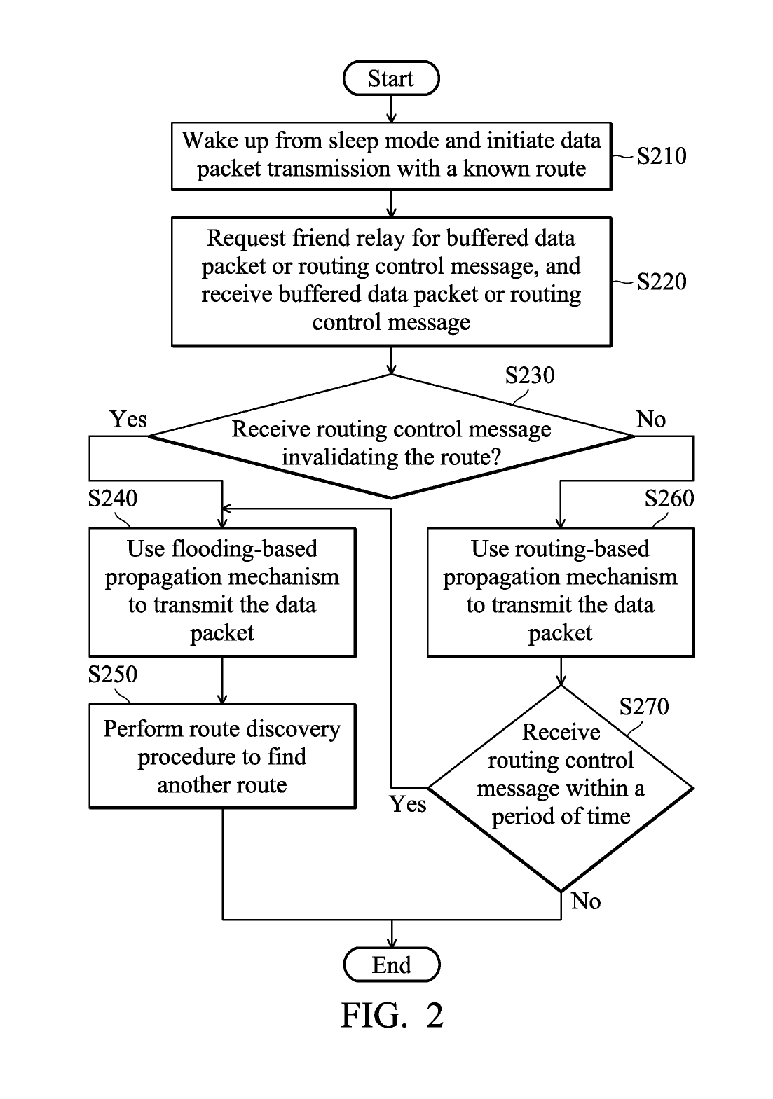

FIG. 2 is a flow chart illustrating the method for a wireless communication device serving as an edge node to propagate packets in a wireless mesh network according to an embodiment of the application. In this embodiment, the wireless communication device is a Bluetooth Mesh Routing-enabled node which supports both the flooding-based propagation mechanism and the routing-based propagation mechanism. To begin, the wireless communication device wakes up from the sleep mode and initiates a data packet transmission with a known route towards the destination node (step S210). In response to initiating the data packet transmission, the wireless communication device requests its friend relay for any data packet or routing control message buffered for the wireless communication device, and receives the buffered data packet or routing control message (step S220). The data packet may also be referred to as an application message, and the routing control message may also be referred to as a route-information-related packet.

Next, the wireless communication device determines whether a routing control message invalidating the route is received from the friend relay (step S230).

In one embodiment, the routing control message invalidating the route may be a Route Error message which may be referred to as an RERR in the Bluetooth Mesh Routing specifications.

Note that the routing control message is already buffered in the friend relay when the wireless communication device initiates the data packet transmission, and thus, the routing control message should correspond to a previous data packet transmission before the wireless communication device enters the sleep mode.

Subsequent to step S230, when such a routing control message is received, the wireless communication device uses the flooding-based propagation mechanism to transmit the data packet to the destination node (step S240). Next, the wireless communication device performs the route discovery procedure to find another route towards the destination node (step S250), and the method ends.

Please note that the detailed descriptions regarding the route discovery procedure are omitted herein as they are beyond the scope of the application, and reference may be made to the Bluetooth Mesh Routing specifications.

Subsequent to step S230, when no such routing control message is received, the wireless communication device uses the routing-based propagation mechanism to transmit the data packet to the destination node (step S260). Next, the wireless communication device determines whether a routing control message which corresponds to the data packet transmission and invalidates the route is received within a period of time subsequent to the data packet transmission using the routing-based propagation mechanism (step S270).

In one embodiment, the period of time may refer to a guard timer period for waiting for an Acknowledgement (ACK) of the data packet transmission, if the data packet transmission requires an ACK from the destination node. In another embodiment, the period of time may be a predetermined period of time for monitoring the Route Error message, if the data packet transmission does not require an ACK from the destination node.

Subsequent to step S270, when no routing control message invalidating the route is received within the period of time, the method ends.

Subsequent to step S270, when a routing control message invalidating the route is received within the period of time, the method proceeds to step S240. That is, the wireless communication device switches to use the flooding-based propagation mechanism to retransmit the data packet.

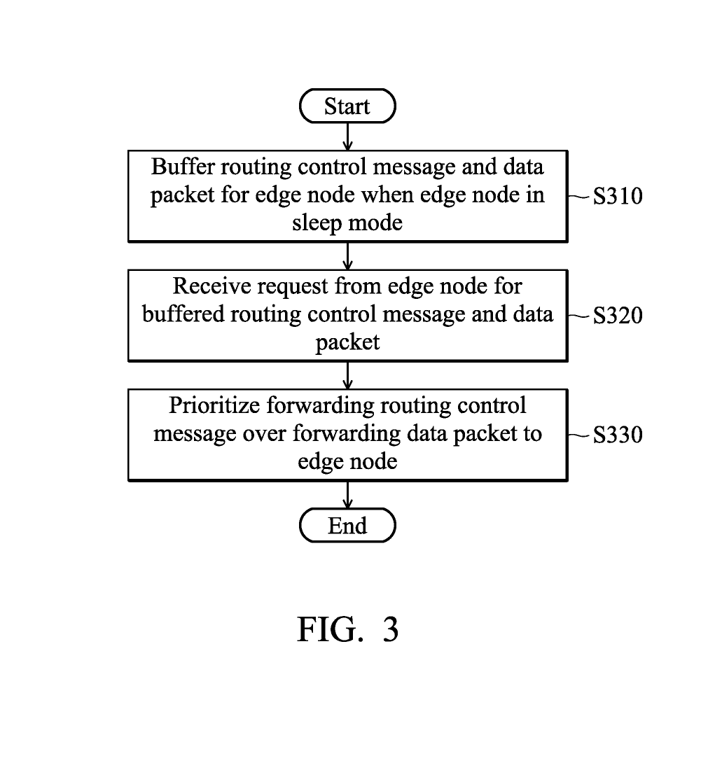

FIG. 3 is a flow chart illustrating the method for a wireless communication device serving as a friend relay of an edge node to propagate packets in a wireless mesh network according to an embodiment of the application. To begin, the wireless communication device buffers at least a routing control message and at least a data packet for the edge node when the edge node enters the sleep mode (step S310).

Subsequently, the wireless communication device receives a request from the edge node for the buffered routing control message and data packet (step S320). That is, the edge node wakes up from the sleep mode and sends out the request for the buffered packets.

After that, the wireless communication device prioritizes forwarding the routing control message over forwarding the data packet to the edge node (step S330). That is, the buffered routing control message is transmitted before the buffered data packet, so that the up-to-date route information may be provided to the edge node as soon as possible.

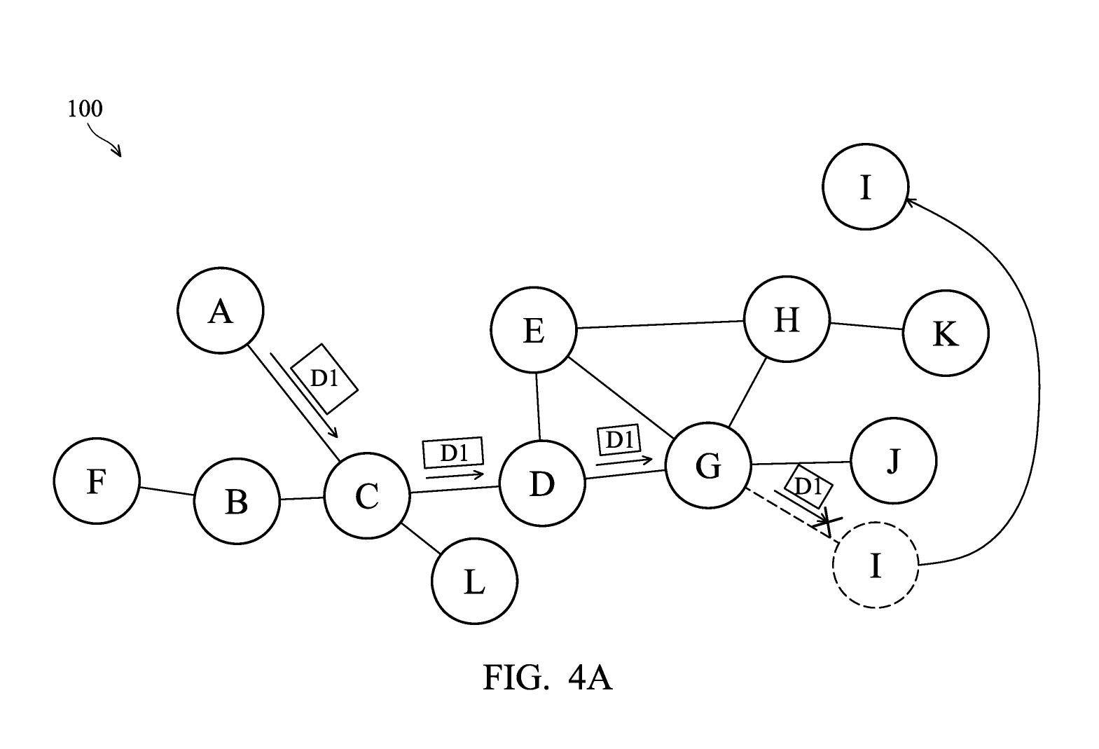

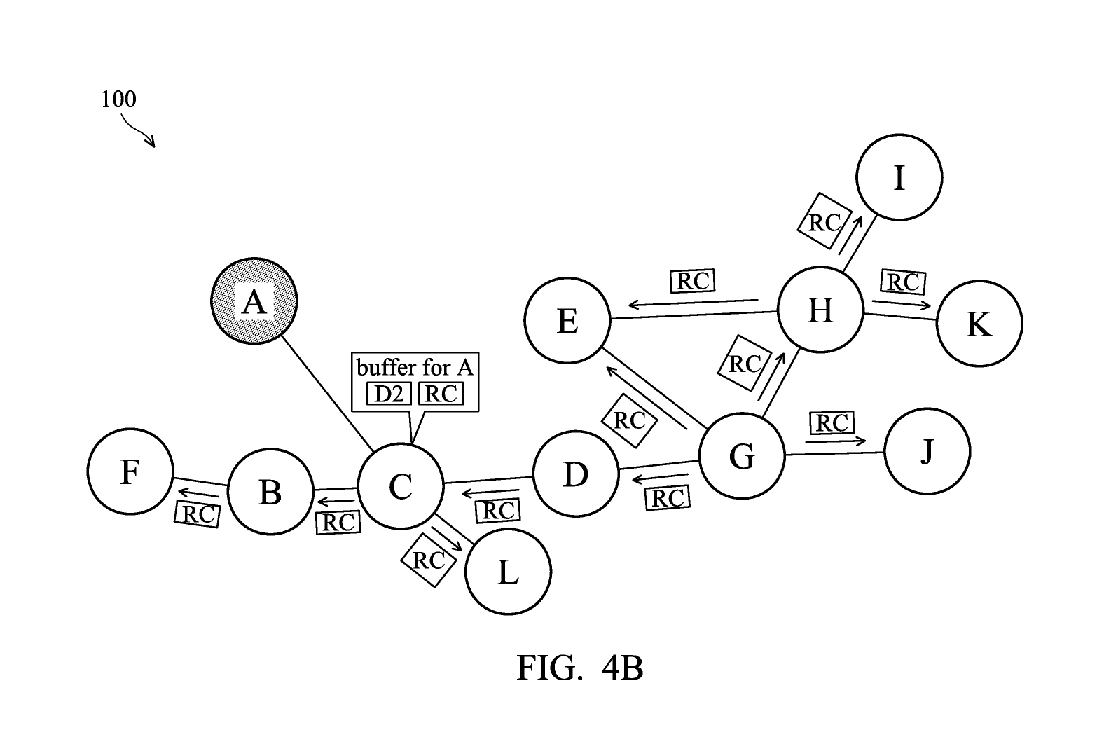

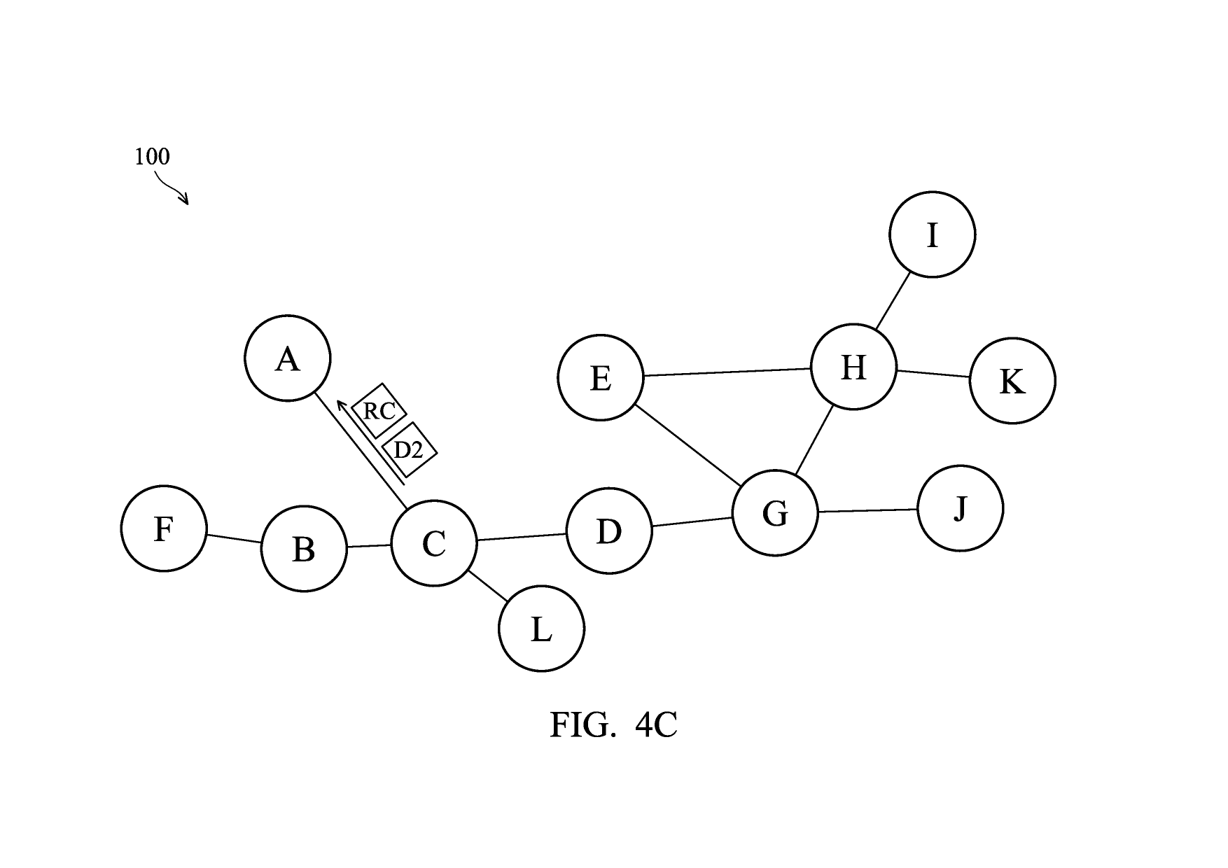

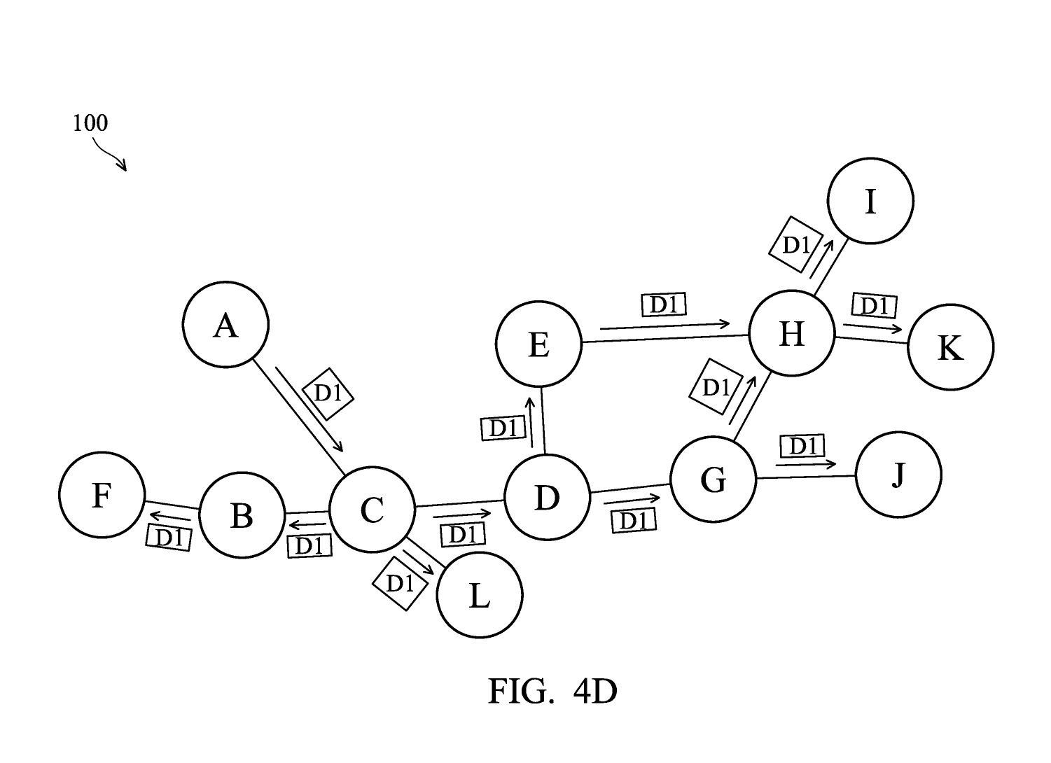

FIGS. 4A to 4D are schematic diagrams illustrating packet propagation according to an embodiment of the application. The wireless mesh network 100 includes a plurality of wireless communication devices A to L, wherein the wireless communication devices A, F, I, J, K, L are edge nodes which are unable to forward data packets and the wireless communication devices B, C, D, E, G, H are relay nodes which have the ability to forward data packets using the flooding-based or routing-based propagation mechanism.

As shown in FIG. 4A, the wireless communication device A originates propagation of a data packet (denoted as D1) according to a route known towards the wireless communication device I, i.e., the destination node. The route starts from the wireless communication device A and passes through the wireless communication devices C, D, G, and finally leads to the wireless communication device I. However, before the data packet is propagated to the wireless communication device I, the wireless communication device I has moved out of reach of the wireless communication device G. Therefore, the forwarded data packet from the wireless communication device G fails to reach the wireless communication device I.

As shown in FIG. 4B, the wireless communication device G broadcasts a routing control message invalidating the route. When receiving the routing control message, the wireless communication device C buffers the routing control message due to the wireless communication device A being in the sleep mode (denoted with a grey background). Note that, in addition to the routing control message, the wireless communication device C also buffers a data packet (denoted as D2) which is received when the wireless communication device A is in the sleep mode.

As shown in FIG. 4C, when waking up from the sleep mode (denoted with a white background), the wireless communication device A requests the wireless communication device C for the buffered packets. The wireless communication device C specifically forwards to the wireless communication device A the buffered routing control message first and then the buffered data packet next.

As shown in FIG. 4D, when receiving the routing control message invalidating the route to the destination node, the wireless communication device A switches from using the routing-based propagation mechanism to using the flooding-based propagation mechanism, to retransmit the data packet.

In view of the forgoing embodiments, it will be appreciated that the present application achieves fast recovery from failures of packet propagation using the routing-based propagation mechanism, by enabling the originating edge node to request the friend relay for buffered packets before initiating any data packet transmission and to switch to use the flooding-based propagation mechanism instead for retransmitting the failed data packets, and by enabling the friend relay to prioritize forwarding the buffered routing control message over forwarding the buffered data packets for the originating edge node. Advantageously, the latency for propagating data packets may be reduced in a wireless mesh network supporting both flooding-based and routing-based relaying.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

What is claimed is:

1. A wireless communication device, serving as an edge node in a wireless mesh network, comprising:
a wireless transceiver configured to perform wireless transmission and reception in the wireless mesh network; and
a controller configured to use a routing-based propagation mechanism to transmit, via the wireless transceiver, a data packet to a destination node in the wireless mesh network when a route is known towards the destination node, and use a flooding-based propagation mechanism to transmit, via the wireless transceiver, the data packet to the destination node when receiving a routing control message invalidating the route.

2. The wireless communication device as claimed in claim 1, wherein the controller is further configured to request a friend relay of the wireless communication device for any data packet or routing control message buffered for the wireless communication device, prior to the data packet transmission using the routing-based propagation mechanism or the flooding-based propagation mechanism.

3. The wireless communication device as claimed in claim 2, wherein the data packet transmission using the routing-based propagation mechanism is performed when no routing control message, which invalidates the route, is buffered in the friend relay.

4. The wireless communication device as claimed in claim 2, wherein, when a routing control message, which invalidates the route, is buffered in the friend relay, the controller is further configured to receive the routing control message from the friend relay.

5. The wireless communication device as claimed in claim 1, wherein the controller is further configured to perform a route discovery procedure to find another route towards the destination node, after the data packet transmission using the flooding-based propagation mechanism.

6. The wireless communication device as claimed in claim 1, wherein the data packet transmission using the routing-based propagation mechanism requires an Acknowledgement (ACK) from the destination node, and the routing control message is received before a guard timer for waiting for the ACK expires.

7. The wireless communication device as claimed in claim 1, wherein the data packet transmission using the routing-based propagation mechanism does not require an ACK from the destination node, and the routing control message is received within a predetermined period of time.

8. A method for a wireless communication device serving as an edge node to propagate packets in a wireless mesh network, the method comprising:
using a routing-based propagation mechanism to transmit a data packet to a destination node in the wireless mesh network when a route is known towards the destination node; and
using a flooding-based propagation mechanism to transmit the data packet to the destination node when receiving a routing control message invalidating the route.

9. The method as claimed in claim 8, further comprising:
requesting a friend relay of the wireless communication device for any data packet or routing control message buffered for the wireless communication device, prior to the data packet transmission using the routing-based propagation mechanism or the flooding-based propagation mechanism.

10. The method as claimed in claim 9, wherein the data packet transmission using the routing-based propagation mechanism is performed when no routing control message, which invalidates the route, is buffered in the friend relay.

11. The method as claimed in claim 9, wherein, when a routing control message, which invalidates the route, is buffered in the friend relay, the controller is further configured to receive the routing control message from the friend relay.

12. The method as claimed in claim 8, further comprising:
performing a route discovery procedure to find another route towards the destination node, after the data packet transmission using the flooding-based propagation mechanism.

13. The method as claimed in claim 8, wherein the data packet transmission using the routing-based propagation mechanism requires an Acknowledgement (ACK) from the destination node, and the routing control message is received before a guard timer for waiting for the ACK expires.

14. The method as claimed in claim 8, wherein the data packet transmission using the routing-based propagation mechanism does not require an ACK from the destination node, and the routing control message is received within a predetermined period of time.

15. A wireless communication device, serving as a friend relay of an edge node in a wireless mesh network, comprising:
a wireless transceiver configured to perform wireless transmission and reception in the wireless mesh network; and
a controller configured to buffer a routing control message and a data packet for the edge node when the edge node enters a sleep mode, and prioritize forwarding the routing control message over forwarding the data packet to the edge node when the edge node wakes up from the sleep mode.

16. The wireless communication device as claimed in claim 15, wherein the routing control message invalidates a route towards a destination node of a data packet transmitted from the edge node.

17. The wireless communication device as claimed in claim 15, wherein the wireless communication device is a Bluetooth Mesh Routing-enabled Relay.

18. A method for a wireless communication device serving as a friend relay of an edge node to propagate packets in a wireless mesh network, the method comprising:
buffering a routing control message and a data packet for the edge node when the edge node enters a sleep mode; and
prioritizing forwarding the routing control message over forwarding the data packet to the edge node when the edge node wakes up from the sleep mode.

19. The method as claimed in claim 18, wherein the routing control message invalidates a route towards a destination node of a data packet transmitted from the edge node.

20. The method as claimed in claim 18, wherein the wireless communication device is a Bluetooth Mesh Routing-enabled Relay.
